(19) United States
(12) Patent Application Publication
(10) Pub. No.: US 2019/0151983 A1
(43) Pub. Date: May 23, 2019

(54) ULTRASONIC WELDING/BRAZING A STEEL WORKPIECE OVER ALUMINUM ALLOYS

(71) Applicant: GM GLOBAL TECHNOLOGY OPERATIONS LLC, DETROIT, MI (US)

(72) Inventors: Huaxin Li, Rochester Hills, MI (US); Qigui Wang, Rochester Hills, MI (US); Daniel J. Wilson, Linden, MI (US)

(21) Appl. No.: 15/817,605

(22) Filed: Nov. 20, 2017

(51) Int. Cl. B23K 20/24; B23K 20/10; B23K 35/28; B23K 26/362

(52) U.S. Cl. CPC B23K 20/24; B23K 20/10; B23K 2203/04; B23K 26/362; B23K 35/282

(57) ABSTRACT

A method for simultaneous ultrasonic welding/brazing of a first metallic alloy workpiece over a second metallic alloy workpiece includes creating depressions in a joining surface of a first metallic alloy workpiece, and applying a coating material to at least one of the joining surface of the first metallic alloy workpiece or a joining surface of a second metallic alloy workpiece. Next, contaminates are removed from the joining surfaces of the first metallic alloy workpiece and the second metallic alloy workpiece, and the workpieces are joined using ultrasonic vibration to create a welded and brazed joint.

### FIELD

The present disclosure relates to a joining method, and more particularly, a method for simultaneous ultrasonic welding/brazing of a first metallic alloy workpiece over a second metallic alloy workpiece to form metallurgic bonding.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

In a typical automobile, certain components are welded together. Some welds involve components made of different alloys. For example, a lighter alloy such as aluminum or magnesium may be joined with a heavier alloy such as steel. Because of the physical and metallurgical property differences between these alloys, the joint strength may not be strong enough for certain applications. Specifically, brittle intermetallic compound formation and high residual stresses in the weld joint resulting from the use of alloys with different properties may limit the joint strength.

These limitations may prevent and/or reduce the ability to reduce the mass of automotive components which, in turn, may prevent and/or reduce the fuel efficiency, economy, performance, battery life, range and other important characteristics of an automobile. Thus, there is a desire to have a reliable process for joining alloys of different physical and metallurgic properties that results in high joint strength.

### SUMMARY

One or more exemplary embodiments address the above issue by providing a method for simultaneous ultrasonic welding/brazing of a first metallic alloy workpiece over a second metallic alloy workpiece.

In accordance with an exemplary embodiment, a method for simultaneous ultrasonic welding/brazing of a first metallic alloy workpiece over a second metallic alloy workpiece includes creating depressions in a joining surface of a first metallic alloy workpiece. Another aspect of the exemplary embodiment includes applying a coating material to at least one of the joining surface of the first metallic alloy workpiece or a joining surface of a second metallic alloy workpiece. And another aspect includes removing contaminates from the joining surfaces of the first metallic alloy workpiece and the second metallic alloy workpiece. And still another aspect includes joining the first metallic alloy workpiece and the second metallic alloy workpiece at the joining surfaces using ultrasonic vibration to create a welded and brazed joint with metallurgical bonding.

A further aspect in accordance with the exemplary embodiment wherein creating further includes creating depressions in a joining surface of a steel workpiece. And yet another aspect wherein applying further includes applying a coating material to at least one of the joining surface of the steel workpiece or a joining surface of an aluminum workpiece. And still another aspect wherein applying further includes applying a coating of a lower melting temperature alloy material to at least one of the joining surfaces. And one other aspect wherein applying a coating of a lower melting temperature alloy material further includes applying a coating of a Zinc alloy.

Still other aspects in accordance with the exemplary embodiment wherein creating depressions further includes creating grooves or dimples in the joining surface of the first metallic alloy workpiece, and wherein creating depressions further includes making the depressions 0.020 mm-0.20 mm in depth. And further aspects wherein creating depressions further includes using a steel workpiece 0.2 mm-2.0 mm thick, and wherein removing further includes using a laser beam to remove contaminates less than or equal to 0.020 mm in height from an uncoated aluminum joining surface.

In this manner, a component may be provided having a significantly reduced mass while ensuring a strong bond between dissimilar metals, such as, for example, steel and aluminum, by reducing and/or eliminating the potential for brittle intermetallic compounds forming at the interface. This is especially valuable in an automotive part, such as in a vehicle propulsion system, where a reduction of mass may provide significant improvements in fuel economy, efficiency, performance, extended range, increased battery life and the like.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is an illustration of an ultrasonic welding system in accordance with aspects of an exemplary embodiment;

FIG. 2 is an illustration of the joining surfaces of the metallic workpieces in accordance with aspects of the exemplary embodiment; and

FIG. 3 is an illustration of a flow diagram of a method for simultaneous ultrasonic welding/brazing of a first metallic alloy workpiece over a second metallic alloy workpiece in accordance with aspects of the exemplary embodiment.

In the drawings, reference numbers may be reused to identify similar and/or identical elements.

### DETAILED DESCRIPTION

The following description discloses the use of ultrasonic energy to join a first metallic alloy workpiece to a second metallic alloy workpiece by simultaneous solid state welding and brazing to obviate known issues, e.g., brittle and weak weld joints, that commonly result from join dissimilar metals and/or alloys.

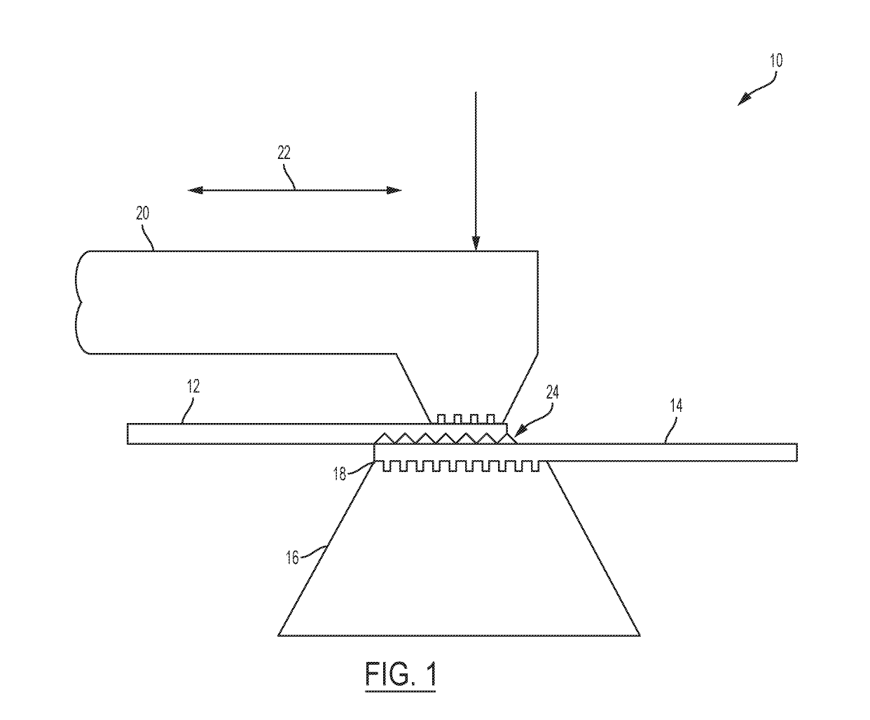

Referring now FIG. 1, an illustration of an ultrasonic welding system 10 in accordance with aspects of an exemplary embodiment is provided. In this illustration, a first metallic alloy workpiece 12 is being joined to a second metallic alloy workpiece 14 is the ultrasonic welding system 10. In this case, the first metallic alloy workpiece and the second metallic alloy workpiece have dissimilar physical and metallurgic properties, i.e., steel and aluminum. It is appreciated that aspects in accordance with the disclosed method can be used with other dissimilar metallic materials without exceeding the scope of the exemplary embodiment.

The ultrasonic system 10 may include an anvil 16 for supporting a workpiece to be joined to another workpiece during the weld process. The anvil 16 may also be disposed with a textured surface for aiding in preventing the supported workpiece from shifting about the support surface. The ultrasonic welding system 10 includes an acoustic horn 16 used for augmenting the oscillation displacement amplitude provided by an ultrasonic transducer (not shown) operating at the low end of the ultrasonic frequency spectrum because the amplitudes provided by the transducers themselves are insufficient for most practical applications of power such as welding. The acoustic horn 20 also serves to efficiently transfer acoustic energy from the transducer(s) to the workpiece. The acoustic energy creates ultrasonic vibrations 22 that are locally applied to the workpieces being held together under pressure on the anvil 16 to create a solid-state weld joint 24.

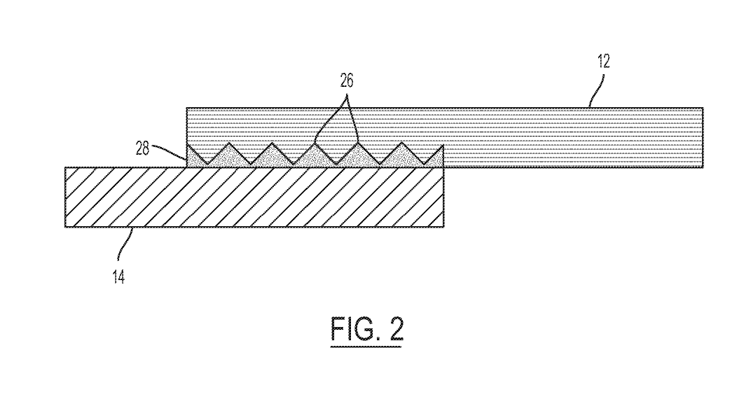

Referring now to FIG. 2, an illustration of the joining/fay surfaces of the metallic workpieces in accordance with aspects of the exemplary embodiment is provided. The fay surface of the first metallic workpiece allow 12 includes a plurality of depressions 26 to enhance metallurgical and mechanical bonding integrity, reduce residual stresses and increase strength at the weld joint between the first metallic alloy workpiece 12 and the second metallic alloy workpiece 14. The depressions 26 may be in the form of dimples or grooves that may range from 0.020 mm-0.20 mm in depth in accordance with the exemplary embodiment although it is appreciated that other depths used for the intended purpose are not beyond the scope of this disclosure. The thickness of the first metallic alloy workpiece, i.e., steel, can range between 0.2 mm-2.0 mm thick. A coating material 28 is applied to at least one of the joining surface of the first metallic alloy workpiece 12 or a joining surface of the second metallic alloy workpiece 14. Preferably, the coating material 28 is a lower melting temperature alloy material such as a Zinc alloy in the case of steel and aluminum workpieces.

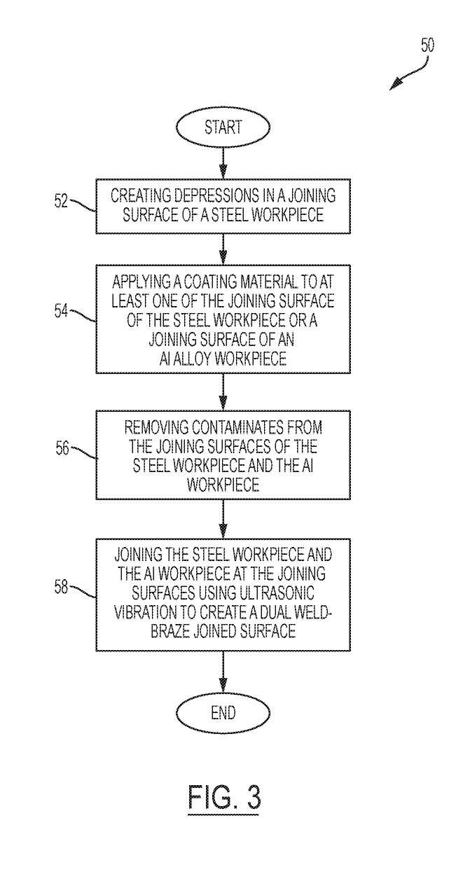

FIG. 3 an illustration of a flow diagram of a method 50 for simultaneous ultrasonic welding/brazing of a first metallic alloy workpiece over a second metallic alloy workpiece in accordance with aspects of the exemplary embodiment. The method begins at block 52 with creating depressions in a joining surface of a first metallic alloy workpiece. This can be performed manually with appropriate tooling a using a machine.

At block 54, the method continues with applying a coating material to at least one of the joining surface of the first metallic alloy workpiece or a joining surface of the second metallic alloy workpiece. The coating material should be of an alloy that has a lower melting temperature than the workpieces. Next, at block 56, the method continues with removing contaminates from the joining surfaces of the first metallic alloy workpiece and the second metallic alloy workpiece. If contaminates on an uncoated aluminum joining surface are less than or equal to 0.020 mm in height from the surface of the aluminum then a laser beam should be used to remove them.

At block 58, the method continues with joining the first metallic alloy workpiece and the second metallic alloy workpiece at the joining surfaces using ultrasonic vibration to create a welded and brazed joint.

While the present detailed description describes a friction welding process, it is to be understood that exemplary embodiments of the present disclosure include any solid state welding process, such as, for example, cold welding, diffusion welding, ultrasonic welding, explosion welding, forge welding, friction welding, hot pressure welding, roll welding and the like. Solid state welding joins the base metals without significant melting of the base metals.

Further, while the present detailed description describes and illustrates a steel gear and aluminum clutch shell, it is to be understood that exemplary embodiments of the present disclosure may be applicable to combining two dissimilar alloys to form a single component such that brittle intermetallic compounds are not formed at the interface. Exemplary embodiments of the present disclosure may be useful in providing components for an automobile such as in a vehicle propulsion system,

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for ultrasonic welding and brazing of a steel alloy workpiece over an aluminum alloy workpiece to a form metallurgic bond comprising:
creating depressions in a joining surface of at least one of the steel alloy workpiece or the aluminum alloy workpiece;
applying a coating material to at least one of the joining surface of the steel alloy workpiece or the joining surface of the aluminum alloy workpiece;
removing contaminates from the joining surfaces of the steel alloy workpiece and the aluminum alloy workpiece; and
joining the steel alloy workpiece and the aluminum alloy workpiece at the joining surfaces using ultrasonic vibration to create a welded and brazed joint with metallurgic bonding.

2. (canceled)

3. The method of claim 1 wherein applying further comprises applying a coating material to at least one of the joining surface of the steel workpiece or a joining surface of an aluminum workpiece.

4. (canceled)

5. The method of claim 3 wherein applying a coating of a lower melting temperature alloy material further comprises applying a coating of a Zinc alloy.

6. The method of claim 1 wherein creating depressions further comprises creating grooves or dimples in the joining surface of the steel alloy workpiece.

7. The method of claim 1 wherein creating depressions further comprises making the depressions 0.020 mm-0.20 mm in depth.

8. The method of claim 1 wherein creating depressions further comprises using a steel workpiece 0.2 mm-2.0 mm thick.

9. The method of claim 8 wherein removing further comprises using a laser beam to remove contaminates less than or equal to 0.020 mm in height from an uncoated aluminum joining surface.

10. (canceled)

11. (canceled)

12. (canceled)

13. (canceled)

14. (canceled)

15. (canceled)

16. (canceled)
